(19) United States
(12) Patent Application Publication
(10) Pub. No.: US 2014/0057040 A1
(43) Pub. Date: Feb. 27, 2014

(54) Method of Making a Milk Protein Composition

(71) Applicants: Albert van der Padt, Apeldoorn (NL); Gijsbert Klarenbeek, Ommen (NL); Antonius Petrus Julius Sweere, Veghel (NL); Andries Dirk Siemensma, Leeuwarden (NL); Johannes Andries Nieuwenhuijse, Eefde (NL)

(72) Inventors: Albert van der Padt, Apeldoorn (NL); Gijsbert Klarenbeek, Ommen (NL); Antonius Petrus Julius Sweere, Veghel (NL); Andries Dirk Siemensma, Leeuwarden (NL); Johannes Andries Nieuwenhuijse, Eefde (NL)

(73) Assignee: Friesland Brands B.V., Amersfoort (NL)

(21) Appl. No.: 14/114,280

(22) PCT Filed: Apr. 26, 2012
(86) PCT No.: PCT/NL12/50282

§ 371 Date: Oct. 28, 2013

(30) Foreign Application Priority Data
Apr. 26, 2011 (NL) 2006662

(51) Int. Cl. A23J 1/20

(52) U.S. Cl. CPC A23J 1/207
USPC 426/580; 426/491

(57) ABSTRACT

Described is a method of of providing milk proteins from raw animal milk. The method comprises subjecting the milk to two microfiltration steps. One is warm microfiltration at 25° C.-65° C. and the other is cold microfiltration at 0° C.-25° C. The steps can be conducted in either order, with a retentate obtained in the first step being subjected to the second step. The resulting milk serum proteins and β-casein are suitable for use in infant or toddler formula.

### FIELD OF THE INVENTION

The invention relates to a method of providing milk proteins. Particularly, the invention relates to a method of making a milk protein composition for infant and toddler formula.

### BACKGROUND OF THE INVENTION

It is well-established that human breast milk is a preferred food for infants and toddlers. However, in many instances human milk is insufficiently available, or breastfeeding is not possible or desirable for other reasons. In these cases, infant food based on cow's milk is generally regarded as a good alternative. Because cow's milk and human milk are significantly different in composition, in particular protein composition, already a great deal of research has been carried out to make the composition of infant food approximate that of human milk as best as possible. This process is also referred to as humanizing cow's milk.

A background reference on rendering bovine milk into protein compositions that can be used to simulate human milk protein is U.S. Pat. No. 5,169,666. Herein bovine milk is subjected to low temperature ultrafiltration or microfiltration, with the milk having been pretreated at about 4° C. for four hours or more. The latter is said to serve the micellar dissociation of β-casein, as a result of which permeates are obtained in which other caseins are reduced. Preferably β-lactoglobulin is reduced, which is done by pH adjustments and sodium chloride addition.

Another background reference is EP 1 133 238. Herein a protein composition, derived from whey, is manufactured by subjecting milk that has not been heat-treated, or at most has undergone a moderate heat treatment, to microfiltration at elevated temperature (typically 50° C.).

A further background reference is WO 2008/127104. This concerns a serum protein product suitable as an ingredient for e.g. babyfoods, which is obtained by micro-filtration of bovine milk at a temperature of 10° C.-20° C. utilizing a membrane having a pore size of between 0.3 and 0.5 μm.

Although the art, including the foregoing references, is well-advanced in processes of providing specific protein compositions that serve the goals of humanizing bovine milk, the disclosed methods are less suitable to keep up with the constantly growing knowledge. For, with the knowledge of the desired composition of milk-based proteins in infant formula constantly improving, it is desired to provide methods from which different protein compositions can be produced with a greater versatility than available in the art. Further, based on current knowledge, it is desired to provide methods by which particularly α-lactalbumin and β-casein are present in high amounts relative to, respectively, β-lactoglobulin and α-casein.

### SUMMARY OF THE INVENTION

In order to better address one or more of the foregoing desires, the invention, in one aspect, provides a method of providing milk proteins, said method comprising subjecting animal milk, wherein the milk comprises non-denatured milk protein, to a first microfiltration step, so as to obtain a first permeate and a first retentate, and subjecting said first retentate to a second microfiltration step, so as to form a second permeate and a second retentate, wherein said microfiltration steps comprise warm microfiltration at 25° C.-65° C. and cold microfiltration at 0° C.-25° C.

In another aspect, the invention presents a composition comprising milk proteins obtainable by the aforementioned method, said composition comprising at least a portion of the second retentate and/or at least a portion of the second permeate.

In still another aspect, the invention provides the use of milk proteins obtainable by the aforementioned method, as an ingredient in infant or toddler formula.

### DETAILED DESCRIPTION OF THE INVENTION

In a broad sense, the invention pertains to the judicious choice to use, in a combined process, two separate microfiltration steps that allow a separate harvesting of milk serum proteins and β-casein. These steps can be performed in either order.

The two steps concerned are a “warm” microfiltration step, viz. at a temperature of 25° C.-65° C., and a “cold” microfiltration, viz. at a temperature of 0° C.-25° C. The microfiltration is generally conducted using a microfilter having a pore size in the range of from 0.01 μm to 5 μm, preferably 0.05 to 1.2 μm, more preferably 0.1 μm to 0.5 μm, still more preferably 0.2 μm to 0.45 μm.

Suitable microfilters are known in the art and include, e.g., organic spiral wound membranes (such as, e.g., those ex Koch, Synder, DSS), plate and frame system (e.g. as provided by Novasep), or ceramic membranes (e.g. from TAMI, Pall, Atech, among others).

For the microfiltration, any conventional apparatus for crossflow microfiltration can be used. Thus, e.g., use can be made of a spiral-wound microfiltration membrane, for instance as described in EP-A-1673975, or ceramic membranes could be used. Preferably, a process system with multiple spiral-wound modules is used. It has been found that it is helpful that in the crossflow microfiltration process measures are taken for reducing the transmembrane pressure across the membrane, in such a manner that the transmembrane pressure is 2.5 bar at a maximum. For that reason, preferably, the transmembrane pressure (TMP) during microfiltration in a method according to the invention is kept relatively low, that is, 2.5 bar at a maximum. Good results as regards the protein composition of the permeate have for instance been obtained at a maximum transmembrane pressure of 2 bars. The average transmembrane pressure may vary, and is for instance 1.5 or 1.3 or 0.5 bar. In a specific embodiment, the maximum transmembrane pressure is 1 bar, in other embodiments 0.9 bar or lower.

Instead of reducing the transmembrane pressure, a different solution may be the use of microfiltration membranes having a gradient in the porosity or thickness of the membrane layer.

In a method according to the invention, standard microfiltration membranes having a pore size of between 0.05 and 1.0 μm may be used. As is known in general, pore size influences the eventual protein composition of the permeate and the retentate. In the light of the present invention, the pore size proves to have an influence inter alia on both the serum protein to casein ratio and the proportion of beta casein in the casein fraction. In an embodiment, use is made of a membrane, for instance a spiral-wound membrane, having a pore size of between 0.05 and 1.0 μm, preferably between 0.1 and 0.5 μm. Other preferred pore-sizes range from 0.01 μm to 5 μm, preferably 0.1 μm to 1.2 μm and most preferably 0.2 μm to 0.45 μm.

The combined microfiltration steps are conducted starting from milk that comprises non-denatured milk protein. This may refer to raw (untreated) milk, or to milk that has undergone a mild heat treatment. The milk may be whole milk or milk which has been skimmed to a greater or lesser degree, raw milk, bactofuged milk or bactofiltered milk or milk pasteurized under mild conditions or reconstituted from powdered milk dried at low temperature. Preferably, non heat-treated, skimmed raw milk is used. If heat-treated, this is done at a temperature below the denaturing temperature of the relevant milk proteins, preferably below 65° C.

The milk provided to the process of the invention can, in principle, be from any dairy animal. This is mostly cattle, and particularly cow (adult female cattle), but in addition to cattle, the following animals provide milk used by humans for dairy products: Camels, Donkeys, Goats, Horses, Reindeer, Sheep, Water buffalo, Yaks, and moose. Most preferably, the milk used in the invention is cow's milk.

In one embodiment, the warm microfiltration is conducted as the first step. This is preferably done using a ceramic membrane as the microfilter. When milk is subjected to this step, the resulting first permeate comprises milk serum proteins. The resulting first retentate, which comprises milk solids from which at least part of the milk serum proteins have been removed, is then subjected to the cold microfiltration step. In general, said retentate will be diluted, e.g. by diafiltration, prior to the cold microfiltration step. In general, warm microfiltration can be conducted up to a protein concentration of 35% by weight, preferably up to 25% by weight. Since the obtainable protein concentration from cold microfiltration is lower (generally up to 20% by weight, preferably up to 15% by weight), and retentate from the warm microfiltration step that is to be subjected to cold microfiltration, will have to be diluted to a protein concentration of below 15% by weight, generally 5-15 wt. % and preferably not higher than 10 wt. %.

The cold microfiltration step results in a permeate comprising β-casein, small micellar material, and calcium. The retentate of this step comprises α-casein, which can be subjected to, e.g., cheesemaking or caseinate production in a regular manner.

An example of this embodiment is illustrated in Scheme 1 below. Herein the abbreviation “CN” represents the casein fractions mentioned above, “SP” the serum proteins mentioned above and “DM” stands for dry matter. Further, “Ret” stands for “retentate” and “Perm” stands for permeate.

In another embodiment, the cold microfiltration is conducted first. In that case, the first permeate, will comprise part (roughly half) of the milk serum proteins (notably α-lactalbumin and β-lactoglobulin) and β-casein. The first retentate, which will comprise α-casein and the remainder of the milk serum proteins, is then subjected to the warm microfiltration step, so as to obtain a permeate comprising milk serum proteins, and a retentate comprising α-casein.

Examples of this embodiment are illustrated in Schemes 2 and 3 below. Herein the abbreviations have the same meanings as above, whereby it will be understood that the “CN” and “SP” fractions have the compositions as discussed in connection with the present embodiment.

As also indicated in Schemes 1-3 above, in any embodiment, the permeates from both microfiltration steps can be used, in any desired combination, to provide a composition comprising milk proteins. Depending on the microfiltration conditions (for instance pore size, temperature, transmembrane pressure), the ratio of serum protein to casein and/or the content of β-casein can vary. Normally, a serum protein to casein ratio of approximately 60:40 is contemplated in infant food to bring the protein composition in line with human milk as best as possible. On the basis of the method of the invention, this can be achieved by adding skimmed milk to the permeates of the first and second microfiltration steps, e.g. 5-15%, preferably about 10% by volume. Alternatively, other sources of serum proteins and or casein can be employed in order to provide the desired ratio between either type of milk protein.

After carrying out a microfiltration step, the microfiltration permeates may be further treated according to one or more conventional processes, such as ultrafiltration, nanofiltration, ion exchange, electrodialysis, reverse osmosis, desalination, evaporation and spray drying. For instance, Na and K are removed. Also a further ceramic microfiltration can be carried out which serves the purpose of a mild preservation, by filtering out bacteria.

In a preferred embodiment, the method of the invention provides one or more further steps so as to optimize the ratio of α-lactalbumin, at cost of β-lactoglobulin. It is in fact one of the advantages of the combined microfiltration method of the invention, that such a further optimization can be carried out. Thus, a benefit of the embodiment in which the warm microfiltration is the first step, is that a permeate is obtained that comprises a relatively high amount of the available milk serum proteins, typically 0.3% to 0.5% by weight, and that this amount can be subjected to techniques allowing the separation of α-lactalbumin from β-lactoglobulin, such as precipitation or microparticulation of β-lactoglobulin, or a sequential ultrafiltration with a cut-off of 50-70 kDa. These techniques are known to the skilled person, and can be performed on the permeate of the warm microfiltration step, irrespective of whether said step is the first or the second microfiltration step.

In an embodiment wherein the cold microfiltration step is conducted first, and the warm microfiltration step is performed on the retentate of the cold microfiltration, a further preferred embodiment is to also perform a warm microfiltration step on the permeate of the cold microfiltration step. Without wishing to be bound by theory, the molecular weights of the main proteins indicate that this third microfiltration step is capable of resulting in a further improved ratio of α-lactalbumin, at cost of β-lactoglobulin. For, the warm microfiltration of the permeate from cold microfiltration provides the possibility of obtaining α-lactalbumin and β-casein as a permeate, with β-lactoglobulin predominantly present in the retentate.

In another aspect, the invention presents a composition comprising milk proteins obtainable by a method in accordance with any of the aforementioned embodiments, said composition comprising at least a portion of the second retentate and/or at least a portion of the second permeate. Preferably, the entire composition comprises the milk proteins as obtained by the method of the invention. In a preferred embodiment, at least a portion of the first retentate and at least a portion of the second retentate are combined in the composition. In another preferred embodiment, at least a portion of the first permeate and at least a portion of the second permeate are combined in the composition.

In still another aspect, the invention provides the use of milk proteins obtainable by a method in accordance with any of the aforementioned embodiments, as an ingredient in infant or toddler formula.

Infant (baby) formula is generally for use, in addition to or in lieu of human breast milk, with infants up to 12 months old (starter+follow-on). Toddler formula generally refers to growing-up milk (GUM) for children of 12-48 months. Obviously, it is not excluded in accordance with the invention to use the milk proteins and milk protein compositions obtained, also for other purposes such as enteral food, medical nutrition for children and for the elderly.

It will be understood that any nutritional compositions, such as infant or toddler formula, provided in accordance with the invention, may comprise any further conventional ingredients. E.g. it is conventional to add to baby and infant food and therapeutic compositions carbohydrates, such as lactose and oligosaccharides, lipids and ingredients such as vitamins, amino acids, minerals, taurine, carnitine, nucleotides and polyamines, and antioxidants such as BHT, ascorbyl palmitate, vitamin E, α- and β-carotene, lutein, zeaxanthin, lycopene and lecithin. The lipids are mostly of vegetable origin. In addition, the food or the therapeutic composition may be enriched with polyunsaturated fatty acids, such as gamma-linolenic acid, dihomo-gamma-linolenic acid, arachidonic acid, stearidonic acid, eicosapentaenoic acid, docosahexaenoic acid and docosapentaenoic acid. With a view to a proper development of the intestinal flora, probiotics may be added, such as lactobacilli and/or bifidobacteria, as well as prebiotics. A preferred combination of probiotics is for instance Bifidobacterium lactis with L. casei, L. paracasei, L. salivarius or L. reuter. Examples of prebiotics include fuco-, fructo- and/or galacto-oligosaccharides, both short- and long-chain, (fuco)sialyloligosaccharides, branched (oligo) saccharides, sialic acid-rich milk products or derivatives thereof, inulin, carob bean flour, gums, which may or may not be hydrolyzed, fibers, protein hydrolysates, nucleotides, which summing up will be understood not to be exhaustive.

The invention will now be illustrated in the following non-limiting example.

### EXAMPLE

After thermization at 62° C. skimmed milk was subjected to a first microfiltration step. The first batch filtration over an 0.14 μm Tami isoflux membrane took place below 10° C. under mild pressure conditions, typically around 0.6 bar. The milk was concentrated 3 times (Volume Reduction Factor=3). This permeate is referred to as Permeate I.

After this microfiltration, the retentate was diluted 3 times with water (1 part retentate and 2 parts water) and subjected to a second microfiltration step. This retentate was batch filtrated over an 0.14 μm Tami isoflux ceramic membrane at 50° C., again under mild pressure conditions (TMP around 0.6 bar) down to a concentration factor of 4. The permeate of this step is referred to as Permeate II and the retentate as Retentate II, respectively.

For Permeate I, Permeate II and Retentate II protein composition is measured.

Method 1—Casein:

The sample is dissolved or mixed in water and the casein and the denaturated protein is precipitated at pH 4.6. The precipitate of protein is filtered out of the solution and determined separately using Meted 2.

Method 2—Total Protein According to Kjeldahl

A test portion is digested by using a block-digestion apparatus with a mixture of concentrated sulfuric acid and potassium sulfate, using copper (II) sulfate as a catalyst to thereby convert organic nitrogen present to ammonium sulfate. The function of the potassium sulfate is to elevate the boiling point of the sulfuric acid and to provide a stronger oxidizing environment. Excess sodium hydroxide is added to the cooled digest to liberate ammonia. The liberated ammonia is steam distilled, using a semi-automatic steam distillation unit, into an excess of boric acid solution then titrated with hydrochloric acid. The nitrogen content is calculated from the amount of ammonia produced.

Method 3—Nonprotein-Nitrogen (NPN) Content

Protein is precipitated from a test portion by the addition of trichloroacetic acid solution such that the final concentration of trichloroacetic acid in the mixture is approximately 12%. The precipitated milk protein is removed by filtration, and the remaining filtrate contains the non-protein-nitrogen components. The nitrogen content of the filtrate is determined by the procedure described in Method 2.

Serum Protein concentration is calculated as Total protein-Casein-NPN

Method 4—Serum Proteins Measured by CZE

The determination of milk proteins by capillary zone electrophoresis (CZE) is obtained at pH 8.6 in aqueous solutions containing 6 M urea and methylhydroxyethylcellulose, resulting in a complete separation of the proteins. Detection is carried out at UV 214 nm. The various components are identified based on the retention times and determined by the external standards using peak area.

Method 5—Bovine IgG, ELISA

Analyte-specific antibody (capture antibody) is bound to a user-provided polystyrene microplate. Unbound capture antibody is washed away. Plates are blocked and washed. Samples or standards are added and any analyte present is bound by the immobilized antibody. Unbound materials are washed away. A HRP Conjugated Bovine IgG Detection Antibody is used as final step. Unbound Detection Ab is washed away. Tetramethylbenzidine (TMB) substrate solution is added to the wells and a blue colour develops in proportion to the amount of analyte present in the sample. Colour development is stopped turning the colour in the wells to yellow. The absorbance of the colour at 450 nm is measured.

Method 6—Bovine IgA, ELISA

Analyte-specific antibody (capture antibody) is bound to a user-provided polystyrene microplate. Unbound capture antibody is washed away. Plates are blocked and washed. Samples or standards are added and any analyte present is bound by the immobilized antibody. Unbound materials are washed away. A HRP Conjugated Bovine IgA Detection Antibody is used as final step. Unbound Detection Ab is washed away. Tetramethylbenzidine (TMB) substrate solution is added to the wells and a blue colour develops in proportion to the amount of analyte present in the sample. Colour development is stopped turning the colour in the wells to yellow. The absorbance of the colour at 450 nm is measured.

Method 7—Bovine TGF-β1, Milk, ELISA

Analyte-specific antibody (capture antibody) is bound to a user-provided polystyrene microplate. Unbound capture antibody is washed away. Plates are blocked and washed. Samples and standards are added and any analyte present is bound by the immobilized antibody. Unbound materials are washed away. Streptavidin-Horseradish Peroxidase (HRP) is used to bind to the detection antibody. Unbound streptavidin-HRP is washed away. Tetramethylbenzidine (TMB) substrate solution is added to the wells and a blue colour develops in proportion to the amount of analyte present in the sample. Colour development is stopped turning the colour in the wells to yellow. The absorbance of the colour at 450 nm is measured.

Method 8—Bovine TGF-β2, Milk, ELISA

Analyte-specific antibody (capture antibody) is bound to a user-provided polystyrene microplate. Unbound capture antibody is washed away. Plates are blocked and washed. Samples and standards are added and any analyte present is bound by the immobilized antibody. Unbound materials are washed away. Streptavidin-Horseradish Peroxidase (HRP) is used to bind to the detection antibody. Unbound streptavidin-HRP is washed away. Tetramethylbenzidine (TMB) substrate solution is added to the wells and a blue colour develops in proportion to the amount of analyte present in the sample. Colour development is stopped turning the colour in the wells to yellow. The absorbance of the colour at 450 nm is measured.

Method 9—Bovine Lactoferrin, ELISA

Analyte-specific antibody (capture antibody) is bound to a user-provided polystyrene microplate. Unbound capture antibody is washed away. Plates are blocked and washed. Samples or standards are added and any analyte present is bound by the immobilized antibody. Unbound materials are washed away. A HRP Conjugated Bovine Lactoferrin Detection Antibody is used as final step. Unbound Detection Ab is washed away. Tetramethylbenzidine (TMB) substrate solution is added to the wells and a blue colour develops in proportion to the amount of analyte present in the sample. Colour development is stopped turning the colour in the wells to yellow. The absorbance of the colour at 450 nm is measured.

Results:

| | | | Permeate I | Permeate II | Retentate II |
|---|---|---|---|---|---|
| | | VRF | 3.00 | 4 | 4 |
| | | T | 10 | 50 | 50 |
| Casein | Method 1 | % | 0.07 | 0.04 | 12.75 |
| Protein | Method 2 | % | 0.65 | 0.47 | 13.58 |
| NPN | Method 3 | % | 0.16 | 0.06 | 0.07 |
| SP | | % | 0.42 | 0.37 | 0.76 |
| BSA | Method 4 | % | 0.00 | 0.00 | 0.13 |
| α-lactalbumin | Method 4 | % | 0.08 | 0.06 | 0.07 |
| β-lactoglobulin | Method 4 | % | 0.30 | 0.30 | 0.64 |
| Casein | Method 4 | % | 0.20 | 0.10 | 14.60 |
| IgG | Method 5 | μg/ml | 210 | 201 | 170 |
| IgA | Method 6 | μg/ml | 237 | 333 | 319 |
| TGFβ1 | Method 7 | ng/ml | 1.98 | 0.6 | 12 |
| TGFβ2 | Method 8 | ng/ml | 21 | 4.4 | 24 |
| LF | Method 9 | μg/ml | 24 | 22 | 133 |

The table above shows the advantages of combining a microfiltration step at low and at high temperature. The advantages of the specific protein composition of the permeate obtained at low temperature can be combined with both the specific protein composition of the permeate at high temperature and with the higher capacity of the filtration system at high temperature.

The results show e.g. that by combining the two microfiltration steps, the final retentate is highly depleted of the various serum proteins. This will give large freedom with respect to the choice of the serum protein fraction for the final product. At the same time, the serum protein fraction of the final retentate is enriched in e.g. lactoferrin.

By e.g. combining the permeates of the two microfiltration steps, a serum protein product can be obtained with either an improved a-la, casein, TGFβ1 and TGFβ2 content (as compared to a serum protein product obtained in a single microfiltration step at higher temperature), or an improved IgA or casein content (as compared to a serum protein product obtained in a single microfiltration step at lower temperature).

The nutritional advantages of the respective proteins are evident. Immunoglobulins can bind to pathogenic bacteria and viruses. By doing so they may prevent adhesion to intestinal epithelium, but they may also promote the uptake of these pathogens by macrophages and dendritic cells through Ig receptors. This promotes pathogen clearance, but this is also needed for antigen presentation of the pathogens to the immune system, and induction of immune responses. Effective immune responses are needed for clearance of the pathogens in secondary infections.

TGF-β is an anti-inflammatory cytokine that has multiple functions. It is important in the differentiation of intestinal epithelial cells, and thus plays a role in barrier function. It is also a key cytokine that promotes the induction of regulatory T cells, and in inducing the production of IgA in the intestine. As a result, immune responses under the influence of TGF-β are not excessive, and do not induce tissue damage, and can in fact down regulate strong immune responses. In addition, production and excretion of IgA into the intestinal lumen contributes to pathogen clearance in a non-inflammatory manner.

Lactoferrin is a protein that may also have anti-inflammatory properties, but it is mainly known for sequestering iron. Iron is used by pathogenic bacteria, and limiting the iron they can use is of relevance.

TGF-β may primarily have benefits in allergy. TGF-β levels in breast milk correlate with protection against allergy. Immunoglobulins (colostrum) can prevent diarrhea, e.g. in AIDS patients that have recurrent diarrhea, but also when colostrum of immunized cows is used, against E. coli or Rotavirus infections. Finally lactoferrin may prevent bacterial infections in low birth weight children.

1. A method of providing milk proteins, said method comprising subjecting animal milk, wherein the milk comprises non-denatured milk protein, to a first microfiltration step, so as to obtain a first permeate and a first retentate, and subjecting said first retentate to a second microfiltration step, so as to form a second permeate and a second retentate, wherein said microfiltration steps comprise warm microfiltration at 25° C.-65° C. and cold microfiltration at 0° C.-25° C.

2. A method according to claim 1, wherein the warm microfiltration is conducted at 40° C.-60° C.

3. A method according to claim 1, wherein the cold microfiltration is conducted at 0° C.-20° C.

4. A method according to claim 1, wherein the warm microfiltration is conducted using a microfilter having a pore size of 0.01 μm to 5 μm, preferably 0.1 μm to 1.2 μm and most preferably 0.2 μm to 0.45 μm.

5. A method according to claim 1, wherein the cold microfiltration is conducted using a microfilter having a pore size of 0.01 μm to 5 μm, preferably 0.1 μm to 1.2 μm and most preferably 0.2 μm to 0.45 μm.

6. A method according to claim 1, wherein the milk is cow's milk.

7. A method according to claim 1, wherein the retentate of the first microfiltration step is diluted with an aqueous composition, preferably with water, to a protein concentration of 5-15 wt. %, preferably at most 10 wt. %, and said diluted retentate is used in the second microfiltration step.

8. A method according to claim 1, wherein the milk is first subjected to the warm microfiltration step and the retentate thereof is subjected to the cold microfiltration step.

9. A method according to claim 1, wherein the milk is first subjected to the cold microfiltration step and the retentate thereof is subjected to the warm microfiltration step.

10. A method according to claim 1, wherein a further warm microfiltration step is conducted on the permeate of the cold microfiltration step.

11. A composition comprising milk proteins obtainable by a method according to claim 1, said composition comprising at least a portion of the second retentate and/or at least a portion of the second permeate.

12. The composition according to claim 11, wherein at least a portion of the first retentate and at least a portion of the second retentate are combined.

13. The composition according to claim 11, wherein at least a portion of the first permeate and at least a portion of the second permeate are combined.

14. The use of milk proteins obtainable by a method according to claim 1 as an ingredient in infant or toddler formula.

15. A use according to claim 14, wherein the milk proteins are provided in a composition obtained by subjecting animal milk, wherein the milk comprises non-denatured milk protein, to a first microfiltration step, so as to obtain a first permeate and a first retentate, and subjecting said first retentate to a second microfiltration step, so as to form a second permeate and a second retentate, wherein said microfiltration steps comprise warm microfiltration at 25° C.-65° C. and cold microfiltration at 0° C.-25° C., said composition comprising at least a portion of the second retentate and/or at least a portion of the second permeate.
